(19) United States
(12) Patent Application Publication
(10) Pub. No.: US 2024/0060482 A1
(43) Pub. Date: Feb. 22, 2024

(54) ELECTROMAGNETIC FLUID VORTEX POWER DEVICE

(71) Applicant: Xiaobin CHEN, Maoming (CN)

(72) Inventor: Xiaobin CHEN, Maoming (CN)

(21) Appl. No.: 18/261,344

(22) PCT Filed: Feb. 21, 2022
(86) PCT No.: PCT/CN2022/076990

§ 371 Date: Jul. 13, 2023

(30) Foreign Application Priority Data
Mar. 1, 2021 (CN) 202110273251.7

(51) Int. Cl. F03H 1/00

(52) U.S. Cl. CPC F03H 1/0081

(57) ABSTRACT

An electromagnetic fluid vortex power device includes a main air intake, auxiliary air intakes and vortex holes. The auxiliary air intakes are distributed on both sides of the main air intake and are separated by a division wall, the main air intake and the auxiliary air intakes are communicated through the vortex holes to form a communicated space, and a side wall of the main air intake is provided with an electromagnetic starter and an electromagnetic propeller. When the power device starts to work, a working medium generates electrical conductivity due to structures of the electromagnetic starter and the vortex holes and generates an electric field and a magnetic field intersecting with each other. The working medium in the auxiliary air intakes flows into the main air intake through the vortex holes to form vortexes, and then the electromagnetic propellers is started to work stably and persistently.

### FIELD OF TECHNOLOGY

The present invention relates to a power device, and particularly relates to an electromagnetic fluid vortex power device in aviation, aerospace and ship power systems.

### BACKGROUND

Energy sources mostly used in current aviation and aerospace engines are chemical fuels which will generate high temperature and high pressure during work and put a very high requirement on performance of blades of engines, resulting in prolonged research and development period of the engines. The combustion efficiency of the chemical fuels is also a problem. The engines work only when a plenty of devices such as blades are installed in the engines, which causes large weight of the engines, thereby affecting the whole performance of aircrafts. It is difficult to ignite in a special region due to low oxygen content, and the engines are hardly started to work.

To overcome the above defects, the electromagnetic fluid vortex power device can be started to work by electric power, and is not internally provided with other devices such as blades, so that the weight of the device is reduced, and an aircraft can obtain better performance. Meanwhile, the device is not limited to the aircraft, and can further be applied to a ship power system.

### SUMMARY

To solve the above problems, the objective of the present invention is to provide an electromagnetic fluid vortex power device. The working mode of the power device is changed in principle, and the power device is not provided with devices such as blades, so that the weight of the power device is reduced and the thrust can also be improved. Finally, the whole performance of an aircraft is improved.

To realize the above objective, the technical solution of the present invention is as follows:

an electromagnetic fluid vortex power device, including a main air intake, auxiliary air intakes and vortex holes. According to the power device, a fluid as a working medium enters the power device from the main air intake and the auxiliary air intakes, respectively, and the working medium generates the Lorentz force under the joint action of an electric field and a magnetic field intersecting with each other, so that the working medium flows out from the tail end of the power device in the flowing direction, so as to provide the power device with a forward thrust. When the working medium is seawater, owing to electrical conductivity of the seawater itself, the power device only needs to provide the electric field and the magnetic field intersecting with each other inside, and the power device can work in an electrified state; when the working medium is a gas which is usually free of electrical conductivity, it is needed to create a conductible condition for the gas, either adding ions into the gas or ionizing the gas. For example, a high voltage is generated at a tip to ionize the gas, and finally, the power device provides the electric field and the magnetic field intersecting with each other inside, and the power device can work in the electrified state.

Since there are still a large portion of particles in the working medium entering the power device are electrically neutral, the thrust imposed to the working medium will be affected and will be lower than a theoretical calculated value of the Lorentz force. Therefore, vortexes are generated in the power device to improve the moving velocity of the working medium to enhance the collision probability of particles in the state of high-velocity rotation. The momentum generated by the charged particles subjected to the Lorentz force is transferred to the neutral particles, so that the effect of the working medium subjected to the Lorentz force as a whole is improved, and finally, the thrust of the power device is improved.

A formation principle of the vortex and a mathematic ground of intensity control thereof are as follows:

assuming that there is a velocity field \vec{v} in certain space, rotation of the velocity field is solved to obtain:

$$\begin{matrix}∇ \times \vec{v} = \vert \begin{matrix}\dot{i} & \vec{j} & \vec{k} \\ \frac{\partial }{\partial x} & \frac{\partial }{\partial y} & \frac{\partial }{\partial z} \\ {v}_{x} & {v}_{y} & {v}_{z}\end{matrix} \vert \\ = ( \frac{\partial {v}_{z}}{\partial y} - \frac{\partial {v}_{y}}{\partial z} ) \dot{i} + ( \frac{\partial {v}_{x}}{\partial z} - \frac{\partial {v}_{z}}{\partial x} ) \vec{j} + ( \frac{\partial {v}_{y}}{\partial x} - \frac{\partial {v}_{x}}{\partial y} ) \vec{k} \\ = ( \frac{\partial {v}_{z}}{\partial t} \cdot \frac{\partial t}{\partial y} - \frac{\partial {v}_{y}}{\partial t} \cdot \frac{\partial t}{\partial z} ) \dot{i} + ( \frac{\partial {v}_{x}}{\partial t} \cdot \frac{\partial t}{\partial z} - \frac{\partial {v}_{z}}{\partial t} \cdot \frac{\partial t}{\partial x} ) \vec{j} + ( \frac{\partial {v}_{y}}{\partial t} \cdot \frac{\partial t}{\partial x} - \frac{\partial {v}_{x}}{\partial t} \cdot \frac{\partial t}{\partial y} ) \vec{k} \\ = ( \frac{{a}_{z}}{{v}_{y}} - \frac{{a}_{y}}{{v}_{z}} ) \dot{i} + ( \frac{{a}_{x}}{{v}_{z}} - \frac{{a}_{z}}{{v}_{x}} ) \vec{j} + ( \frac{{a}_{y}}{{v}_{z}} - \frac{{a}_{x}}{{v}_{y}} ) \vec{k}\end{matrix} \qquad ( 1 )$$

Since the mass of a mass point is not zero, numerator and denominator in the above equation are simultaneously multiplied by mass m to obtain:

$$∇ \times \vec{v} = ( \frac{{F}_{z}}{{p}_{y}} - \frac{{F}_{y}}{{p}_{z}} ) \dot{i} + ( \frac{{F}_{x}}{{p}_{z}} - \frac{{F}_{z}}{{p}_{x}} ) \vec{j} + ( \frac{{F}_{y}}{{p}_{x}} - \frac{{F}_{x}}{{p}_{y}} ) \vec{k} \qquad ( 2 )$$

wherein αₓ, α_{y}, α_{z}, vₓ, v_{y}, v_{z}, Fₓ, F_{y}, F_{z}, pₓ, p_{y} and p_{z} are accelerations \vec{a}, velocities \vec{v}, components of forces \vec{F} suffered and momenta \vec{p} on x, y and z axes of a mass point, respectively, and t is a time.

Therefore, vortex of the fluid is related to the acceleration and velocity of the mass point or is related to force suffered and momenta of the mass point, which is the formation principle of the vortex.

According to the vortex formation principle, the direction where the working medium flowing in is let to be a positive direction of z axis, the rotating direction of the vortex needed to be formed is parallel to the z axis, so both sides of the main air intake can be perforated, and the working medium is controlled according to the equation (I) or (II) of the vortex, so as to finally form the vortex in the main air intake.

According to the power device, the side wall of the main air intake 1 is provided with the electromagnetic starter 2 and the electromagnetic propeller 3, and the electromagnetic starter 2 is close to the inlet of the main air intake 1, and the electromagnetic propeller 3 is then installed behind the electromagnetic starter 2.

According to the power device, the auxiliary air intakes 4 are distributed on both sides of the main air intake 1.

According to the power device, the vortex holes 5 are located between the main air intake 1 and the auxiliary air intakes 4 and communicate the two regions.

According to the power device, the division walls 6 are distributed on both sides of the main air intake and are inlaid together with the auxiliary air intakes 4.

According to the power device, structures in the electromagnetic starter 2, the electromagnetic propeller 3 and the vortex holes 5 can generate the electric field and the magnetic field intersecting with each other. When the working medium is the gas, the working medium generates electrical conductivity due to the structures in the electromagnetic starter 2 and the vortex holes 5.

The power device disclosed by the present invention has the advantages that by taking electric power as working energy, the power device features small weight, high work efficiency and large thrust, can work normally in regions with low oxygen content, and is wide in application range.

### BRIEF DESCRIPTION OF THE DRAWINGS

FIG. 1 is an A-A section view of a structure of the present invention.

FIG. 2 is a single-sided distribution diagram of structural vortex holes of the present invention.

FIG. 3 is a B-B section view of the structure of the present invention.

In the drawings, 1—main air intake; 2, electromagnetic starter; 3, electromagnetic propeller; 4, auxiliary air intake; 5, vortex hole; 6—division wall.

### DESCRIPTION OF THE EMBODIMENTS

The present invention will be further described below in combination with drawings and embodiments. The following embodiments are used for describing the present invention, but are not used for limiting the scope of the present invention.

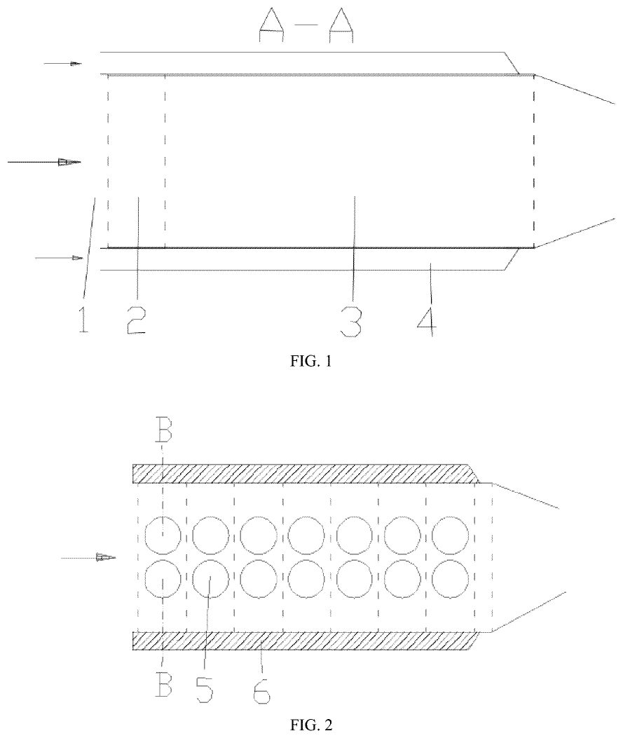

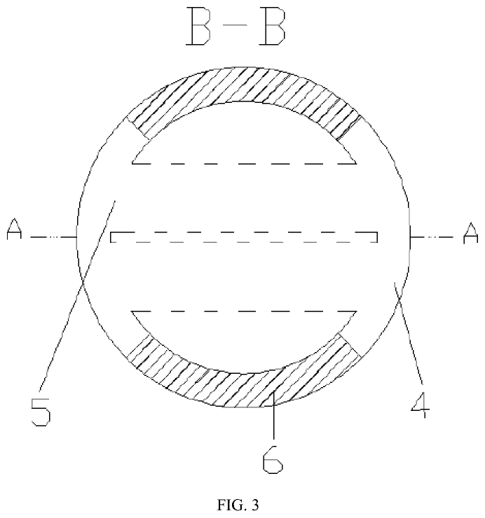

As shown in FIG. 1 and FIG. 2, an electromagnetic fluid vortex power device provided by the present invention includes three structures: a main air intake, auxiliary air intakes and vortex holes. The auxiliary air intakes 4 are located on both sides of the main air intake, are separated by the division wall 6, and are inlaid together to form a tube; the main air intake 1 and the auxiliary air intakes 4 are communicated through the vortex holes 5; the side wall of the main air intake 1 is provided with the electromagnetic starter 2 and the electromagnetic propeller 3, and the electromagnetic starter 2, the electromagnetic propeller 3 and the vortex holes 5 all can generate electric fields and magnetic fields intersecting with each other in the mounted region. When the working medium is the gas, the working medium can generate electrical conductivity due to the electromagnetic starter 2 and the vortex holes 5.

In the embodiment, when the working medium is the gas, structures on the electromagnetic starter 2 and the vortex holes 5 are started first, so that the working medium generates ions with electrical conductivity, and generate the Lorentz force under the joint action of the electric field and the magnetic field, and thus, the working medium enters the power device respectively from the main air intake 1 and the auxiliary air intakes 4 to complete ignition starting work. Since the working medium needs to maintain the electrical conductivity, generating the ions by the working medium is the step proceeded all the time with work of the power device; the fluid near the division wall 6 will flow into the auxiliary air intakes 4 as the power device works, so as to form the working medium.

Then, according to the vortex formation principle, structures on the two parallel vortex holes 5 in one side are controlled, so that the working medium generates different flow rates. Since the same fluid with different flow rates will generate a pressure difference, two working media will generate tangential thrusts, and the directions will deflect as well; the structure of the vortex hole 5 in the other side is controlled in a similar manner, so that the flowing direction of the working medium deflects to the other side of the center, thereby forming the vortex gradually.

Then, the electromagnetic propeller 3 is started. When the working medium flows to the region of the electromagnetic propeller 3, since the structures on the electromagnetic starter 2 and the vortex holes 5 have generated ions in the working medium and the working medium has possessed the electrical conductivity, the electromagnetic propeller 3 can generate the Lorentz force to the working medium only by applying the electric field and the magnetic field intersecting with each other, to maintain normal work so as to generate the thrust.

According other specific embodiments of the electromagnetic fluid vortex power device provided by the present invention, to meet different using demands, the shape of a shell can be changed correspondingly. A choice is made on whether the structures on the electromagnetic starter 2 and the vortex holes 5 further enable the working medium to generate the electrical conductivity can also be made. If necessary, the electromagnetic starter 2 and the electromagnetic propeller 3 can be connected integrally, and the positions thereof can be changed as well. The quantity, size, position and shape of the vortex holes 5 can be adjusted correspondingly. The shape of the division wall can also be changed to facilitate flowing of the fluid according to change of the working environment.

What is mentioned above is only the preferred implementations of the present invention, it should be pointed out that a person of ordinary skill in the art may also make several improvements and modifications without departing from the technical principle of the present invention, and these improvements and modifications should also fall within the scope of protection of the present invention.

What is claimed is:

1. An electromagnetic fluid vortex power device, comprising a main air intake, auxiliary air intakes and vortex holes, wherein a side wall of the main air intake (1) is provided with an electromagnetic starter (2) and an electromagnetic propeller (3); the auxiliary air intakes (4) are divided into two portions, separated by a division wall (6) in the middle, inlaid together and distributed on an outer side of the main air intake (1); the main air intake (1) and the auxiliary air intakes (4) are communicated through vortex holes (5); a fluid as a working medium would enter the power device from the main air intake (1) and the auxiliary air intakes (4), respectively, and the working medium flowing from the auxiliary air intakes (4) would flow into the main air intake (1) through the vortex holes (5) and form vortexes; and sizes and directions of the vortexes can be calculated and controlled according to an equation (I) or (II), the equation being as follows:
$$∇ \times \vec{v} = ( \frac{{a}_{z}}{{v}_{y}} - \frac{{a}_{y}}{{v}_{z}} ) \dot{i} + ( \frac{{a}_{x}}{{v}_{z}} - \frac{{a}_{z}}{{v}_{x}} ) \vec{j} + ( \frac{{a}_{y}}{{v}_{x}} - \frac{{a}_{x}}{{v}_{y}} ) \vec{k} \qquad ( 1 )$$
$$∇ \times \vec{v} = ( \frac{{F}_{z}}{{p}_{y}} - \frac{{F}_{y}}{{p}_{z}} ) \dot{i} + ( \frac{{F}_{x}}{{p}_{z}} - \frac{{F}_{z}}{{p}_{x}} ) \vec{j} + ( \frac{{F}_{y}}{{p}_{x}} - \frac{{F}_{x}}{{p}_{y}} ) \vec{k} \qquad ( 2 )$$
wherein αₓ, α_{y}, α_{z}, vₓ, v_{y}, v_{z}, Fₓ, F_{y}, F_{z}, pₓ, p_{y} and p_{z} are accelerations \vec{a}, velocities \vec{v}, components of forces \vec{F} suffered and momenta \vec{p} on x, y and z axes of a mass point, respectively.

2. The power device according to claim 1, wherein the working medium generates electrical conductivity due to a structure of the electromagnetic starter (2), and an electric field and a magnetic field intersecting with each other can further be generated in a mounted region.

3. The power device according to claim 1, wherein a structure of the electromagnetic propeller (3) generates an electric field and a magnetic field intersecting with each other in the mounted region.

4. The power device according to claim 1, wherein the vortex holes (5) are located in a side wall between the main air intake (1) and the auxiliary air intakes (2), and a structure is mounted, so that the working medium generates the electrical conductivity, and the electric field and the magnetic field intersecting with each other are generated in the mounted region.

5. The power device according to claim 1, wherein a tail end of each of the auxiliary air intakes (4) is a closed structure.

6. The power device according to claim 1, wherein the division wall (6) is a closed structure; and when the power device works, the working medium flows to the auxiliary air intakes (4) from the vicinity of the division wall (6).
